(19) United States
(12) Patent Application Publication
(10) Pub. No.: US 2026/0172140 A1
(43) Pub. Date: Jun. 18, 2026

(54) PROBABILISTIC SHAPING FOR MULTIPLE DATA PORTIONS WITH COUPLED DISTRIBUTIONS

(71) Applicant: QUALCOMM Incorporated, San Diego, CA (US)

(72) Inventors: Pinar SEN, San Diego, CA (US); Wei YANG, San Diego, CA (US); Kirill IVANOV, La Jolla, CA (US)

(21) Appl. No.: 18/984,745

(22) Filed: Dec. 17, 2024

(51) Int. Cl. H04L 1/00

(52) U.S. Cl. CPC H04L 1/0042; H04L 1/0071

(57) ABSTRACT

Methods, systems, and devices for wireless communications are described. A transmitting wireless device may perform probabilistic amplitude shaping (PAS) on one or more portions of a message such that one or more symbols of the transmission may be associated with one or more non-uniform amplitude distributions, while also using uniformly distributed constellation symbols for the remaining portions of the same message. For example, the transmitting wireless device may obtain one or more subsets of bits associated with a uniform information bit distribution. The wireless device may perform one or more shaping operations on one or more of the subsets in accordance with PAS while refraining from performing the shaping operation on one or more subsets. The wireless device may map the subsets of bits to symbols of a transmission, and may transmit the symbol sequence to a receiving wireless device.

### FIELD OF TECHNOLOGY

The following relates to wireless communications, including probabilistic shaping for multiple data portions with coupled distributions.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a wireless device may use OFDM schemes to encode information bits prior to transmission to a second wireless device. Additionally, or alternatively, wireless devices may communicate with the second wireless device using probabilistic amplitude shaping (PAS).

### SUMMARY

The systems, methods, and devices of this disclosure each have several innovative aspects, no single one of which is solely responsible for the desirable attributes disclosed herein.

A method for wireless communications by a wireless device is described. The method may include obtaining one or more subsets of bits, performing both a first shaping operation on a first subset of bits of the one or more subsets of bits in accordance with a first probability distribution and a second shaping operation on a second subset of bits of the one or more subsets of bits in accordance with a second probability distribution different from the first probability distribution, where the first shaping operation and the second shaping operation utilize a same set of shaping parameters, mapping the shaped first subset of bits and the shaped second subset of bits to one or more symbols of a symbol sequence, and transmitting, to a second wireless device, the symbol sequence based on mapping the shaped first subset of bits and the shaped second subset of bits to the one or more symbols.

A wireless device for wireless communications is described. The wireless device may include one or more memories storing processor executable code, and one or more processors coupled with the one or more memories. The one or more processors may individually or collectively be operable to execute the code to cause the wireless device to obtain one or more subsets of bits, perform both a first shaping operation on a first subset of bits of the one or more subsets of bits in accordance with a first probability distribution and a second shaping operation on a second subset of bits of the one or more subsets of bits in accordance with a second probability distribution different from the first probability distribution, where the first shaping operation and the second shaping operation utilize a same set of shaping parameters, map the shaped first subset of bits and the shaped second subset of bits to one or more symbols of a symbol sequence, and transmit, to a second wireless device, the symbol sequence based on mapping the shaped first subset of bits and the shaped second subset of bits to the one or more symbols.

Another wireless device for wireless communications is described. The wireless device may include means for obtaining one or more subsets of bits, means for performing both a first shaping operation on a first subset of bits of the one or more subsets of bits in accordance with a first probability distribution and a second shaping operation on a second subset of bits of the one or more subsets of bits in accordance with a second probability distribution different from the first probability distribution, where the first shaping operation and the second shaping operation utilize a same set of shaping parameters, means for mapping the shaped first subset of bits and the shaped second subset of bits to one or more symbols of a symbol sequence, and means for transmitting, to a second wireless device, the symbol sequence based on mapping the shaped first subset of bits and the shaped second subset of bits to the one or more symbols.

A non-transitory computer-readable medium storing code for wireless communications is described. The code may include instructions executable by one or more processors to obtain one or more subsets of bits, perform both a first shaping operation on a first subset of bits of the one or more subsets of bits in accordance with a first probability distribution and a second shaping operation on a second subset of bits of the one or more subsets of bits in accordance with a second probability distribution different from the first probability distribution, where the first shaping operation and the second shaping operation utilize a same set of shaping parameters, map the shaped first subset of bits and the shaped second subset of bits to one or more symbols of a symbol sequence, and transmit, to a second wireless device, the symbol sequence based on mapping the shaped first subset of bits and the shaped second subset of bits to the one or more symbols.

In some examples of the method, wireless devices, and non-transitory computer-readable medium described herein, performing the shaping operation may include operations, features, means, or instructions for performing the first shaping operation on the first subset of bits and the second shaping operation on the second subset of bits according to a first parameter of the set of shaping parameters, the first parameter of the set of shaping parameters associated with the first probability distribution and the second probability distribution.

Some examples of the method, wireless devices, and non-transitory computer-readable medium described herein may further include operations, features, means, or instructions for transmitting, to the second wireless device, an indication of the first parameter of the set of shaping parameters for use in demodulation of the symbol sequence based on mapping the shaped first subset of bits and the shaped second subset of bits to the one or more symbols.

In some examples of the method, wireless devices, and non-transitory computer-readable medium described herein, mapping the shaped first subset of bits and the shaped second subset of bits to the one or more symbols of the symbol sequence may include operations, features, means, or instructions for mapping the shaped first subset of bits to one or more first symbols of the one or more symbols, where the one or more first symbols may be associated with a first probability, the first probability based on the first parameter and an average energy of the one or more first symbols and mapping the shaped second subset of bits to one or more second symbols of the one or more symbols, where the one or more second symbols may be associated with a second probability, the second probability based on the first parameter and an average energy of the one or more second symbols, and where a quantity of the shaped first subset of bits mapped to the one or more first symbols may be different from a quantity of the shaped second subset of bits mapped to the one or more second symbols.

In some examples of the method, wireless devices, and non-transitory computer-readable medium described herein, the first probability distribution and the second probability distribution may be based on one or more equations associated with one or more parameters of the set of shaping parameters.

In some examples of the method, wireless devices, and non-transitory computer-readable medium described herein, performing both the first shaping operation and the second shaping operation may include operations, features, means, or instructions for performing the first shaping operation on the first subset of bits and the second shaping operation on the second subset of bits according to a first equation of the one or more equations, where the first equation may be associated with at least: a first parameter of the set of shaping parameters associated with the first probability distribution and the second probability distribution; a second parameter of the set of shaping parameters associated with a uniform information bit distribution; a third parameter of the set of shaping parameters associated with the symbol sequence; and a fourth parameter of the set of shaping parameters associated with a modulation mapping function.

Some examples of the method, wireless devices, and non-transitory computer-readable medium described herein may further include operations, features, means, or instructions for performing the first shaping operation on the first subset of bits according to a second equation of the one or more equations, where the second equation may be associated with at least: a first parameter of the set of shaping parameters associated with the first probability distribution and the second probability distribution; and a second parameter of the set of shaping parameters associated with a modulation mapping function and performing the second shaping operation on the second subset of bits according to a third equation of the one or more equations, where the third equation may be associated with at least: the first parameter of the set of shaping parameters; and a third parameter of the set of shaping parameters associated with a uniform information bit distribution.

Some examples of the method, wireless devices, and non-transitory computer-readable medium described herein may further include operations, features, means, or instructions for performing an interleaving operation on the one or more symbols of the symbol sequence according to an interleaving configuration, where transmitting the symbol sequence may be based on performing the interleaving operation.

Some examples of the method, wireless devices, and non-transitory computer-readable medium described herein may further include operations, features, means, or instructions for receiving control signaling including an indication of the interleaving configuration, where performing the interleaving operation on the one or more symbols of the symbol sequence may be based on one or more parameters associated with the indication of the interleaving configuration.

In some examples of the method, wireless devices, and non-transitory computer-readable medium described herein, mapping the shaped first subset of bits and the shaped second subset of bits of the one or more subsets of bits to the one or more symbols of the symbol sequence may include operations, features, means, or instructions for mapping a quantity of bits of the shaped first subset of bits and the shaped second subset of bits to a quantity of symbols of the symbol sequence according to the first probability distribution and the second probability distribution, where the quantity of bits may be less than the quantity of symbols.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

FIGS. 1 and 2 show examples of wireless communications systems that support probabilistic shaping for multiple data portions with coupled distributions in accordance with one or more aspects of the present disclosure.

FIGS. 3A and 3B show examples of a shaping process and diagram that support probabilistic shaping for multiple data portions with coupled distributions in accordance with one or more aspects of the present disclosure.

FIG. 4 shows an example of a process flow that supports probabilistic shaping for multiple data portions with coupled distributions in accordance with one or more aspects of the present disclosure.

FIGS. 5 and 6 show block diagrams of devices that support probabilistic shaping for multiple data portions with coupled distributions in accordance with one or more aspects of the present disclosure.

FIG. 7 shows a block diagram of a communications manager that supports probabilistic shaping for multiple data portions with coupled distributions in accordance with one or more aspects of the present disclosure.

FIG. 8 shows a diagram of a system including a device that supports probabilistic shaping for multiple data portions with coupled distributions in accordance with one or more aspects of the present disclosure.

FIG. 9 shows a flowchart illustrating methods that support probabilistic shaping for multiple data portions with coupled distributions in accordance with one or more aspects of the present disclosure.

### DETAILED DESCRIPTION

In some wireless communications systems, a wireless device may use orthogonal frequency domain modulation (OFDM) schemes to encode information bits prior to transmission. For example, the wireless device may use a OFDM scheme to encode one or more bits into constellation symbols. In some examples, the OFDM scheme may be associated with uniformly-distributed constellation symbols that each have a same length and a same transmission energy. However, generating uniformly-distributed constellation symbols may be inefficient, which may lead to increased processing delays. To increase efficiency of the wireless communications system, the wireless device may implement amplitude shaping for various coded modulation schemes in communicating with a second wireless device. For example, a user equipment (UE) and a network entity may communicate using probabilistic amplitude shaping (PAS). The PAS may be associated with a non-uniform distribution of each constellation symbol amplitude being selected, which may improve the reliability and efficiency of the wireless communications system. However, in some cases, using a non-equal distribution of each constellation symbol amplitude across a transmission may be computationally complex, which may increase inefficiency of the wireless communications system. For example, in the case that a transmission may be associated with multiple layers, implementing PAS on each layer may be inefficient.

To increase efficiency of modulated communications within the wireless communications system, a transmitting wireless device may perform PAS on one or more portions of a message such that one or more symbols of the transmission may be associated with one or more (e.g., multiple) non-uniform amplitude distributions, while also using uniformly distributed constellation symbols for one or more portions of the same message. For example, the transmitting wireless device may obtain one or more subsets of bits. The wireless device may perform a first shaping operation on a first subset of the one or more subsets in accordance with a first PAS and may perform a second shaping operation on a second subset of bits in accordance with a second PAS, while refraining from performing a shaping operation on the remaining subsets. The wireless device may map each of the subsets of bits (e.g., shaped and unshaped bits) to symbols of a transmission, and may transmit the symbol sequence to a receiving wireless device.

Aspects of the disclosure are initially described in the context of wireless communications systems. Aspects of the disclosure are further described in the context of shaping processes and diagrams, and process flows. Aspects of the disclosure are further illustrated by and described with reference to apparatus diagrams, system diagrams, and flowcharts that relate to probabilistic shaping for multiple data portions with coupled distributions.

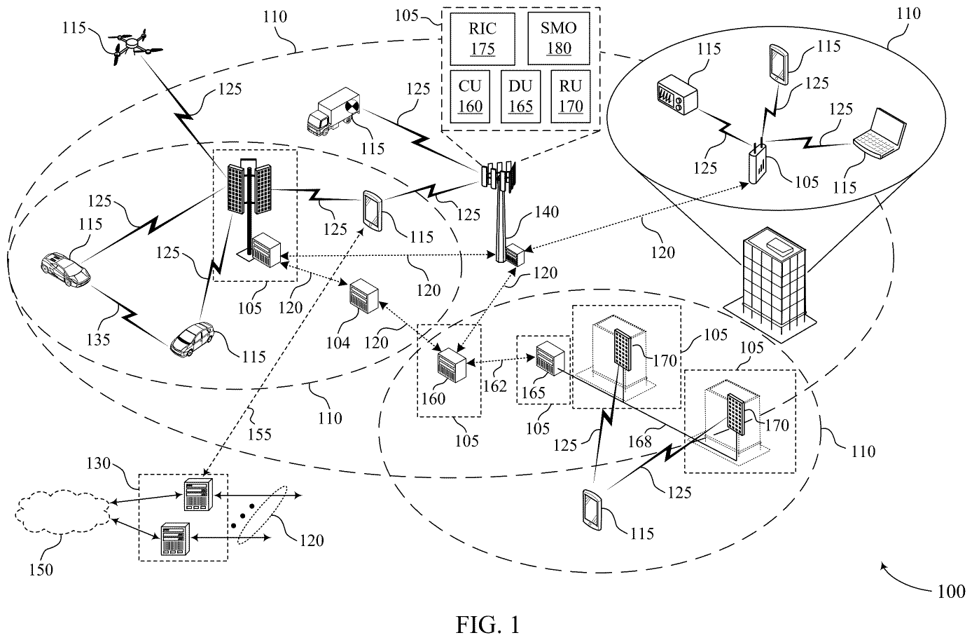

FIG. 1 shows an example of a wireless communications system 100 that supports probabilistic shaping for multiple data portions with coupled distributions in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support probabilistic shaping for multiple data portions with coupled distributions as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δƒₘₐₓ·N_{ƒ}) seconds, for which Δƒₘₐₓ may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In the wireless communications system 100, a transmitting wireless device (e.g., the UE 115, the network entity 105) may use OFDM schemes to encode information bits prior to transmission. For example, the transmitting wireless device may use a OFDM scheme to encode one or more bits into constellation symbols. In some examples, the OFDM scheme may be associated with uniformly-distributed constellation symbols that each have a same length and a same transmission energy. However, generating uniformly-distributed constellation symbols may be inefficient, which may lead to increased processing delays. To increase efficiency of the wireless communications system 100, the transmitting wireless device may implement amplitude shaping for various coded modulation schemes in communicating with a receiving wireless device (e.g., a second UE 115, a second network entity 105). For example, a UE 115 and a network entity 105 may communicate using probabilistic amplitude shaping (PAS). The PAS may be associated with a non-uniform distribution of each constellation symbol amplitude being selected, which may improve the reliability and efficiency of the wireless communications system 100. However, in some cases, using a non-equal distribution of each constellation symbol amplitude across a transmission may be computationally complex, which may increase inefficiency of the wireless communications system 100. For example, in the case that a transmission may be associated with multiple layers, implementing PAS on each layer may be inefficient.

To increase efficiency of modulated communications within the wireless communications system 100, a transmitting wireless device (e.g., the UE 115, the network entity 105) may perform PAS on one or more portions of a message such that one or more symbols of the transmission may be associated with one or more (e.g., multiple) non-uniform amplitude distributions, while also using uniformly distributed constellation symbols for one or more portions of the same message. For example, the transmitting wireless device (e.g., the UE 115, the network entity 105) may obtain one or more subsets of bits. The transmitting wireless device may perform a first shaping operation on a first subset of the one or more subsets in accordance with a first PAS and may perform a second shaping operation on a second subset of bits in accordance with a second PAS while refraining from performing a shaping operation on the remaining subsets. The transmitting wireless device may map each of the subsets of bits (e.g., shaped and unshaped bits) to symbols of a transmission, and may transmit the symbol sequence to a receiving wireless device (e.g., a second UE 115, a second network entity 105).

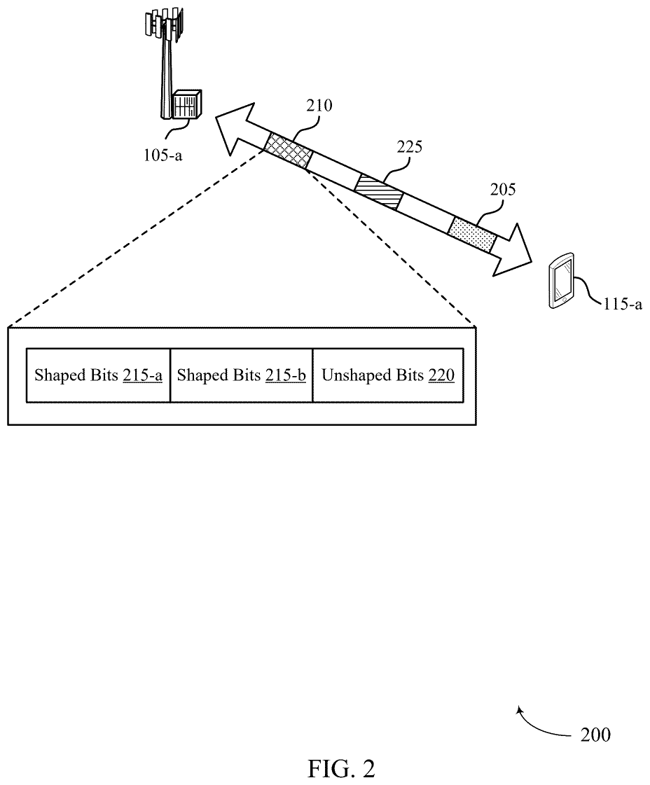

FIG. 2 shows an example of a wireless communications system 200 that supports probabilistic shaping for multiple data portions with coupled distributions in accordance with one or more aspects of the present disclosure. The wireless communications system 200 may be an example of a wireless communications system 100 as described with reference to FIG. 1. For example, the wireless communications system 200 may include a UE 115-a and a network entity 105-a, which may be examples of wireless devices, a UE 115, or a network entity 105 as described with reference to FIG. 1. The network entity 105-a may transmit, and the UE 115-a may receive, control signaling 205. The UE 115-a may communicate information (e.g., sets of information bits) to the network entity 105-a via a symbol sequence 210, which may include one or more subsets of shaped bits 215 and one or more subsets of unshaped bits 220. The UE 115-a may also communicate a probability distribution parameter 225 to the network entity 105-a, which the network entity 105-a may use in decoding the symbol sequence 210.

In the wireless communications system 200, a transmitting device may use OFDM schemes to encode information bits prior to transmission. For example, the UE 115-a may use a OFDM scheme to encode one or more bits into constellation symbols prior to transmitting the bits to the network entity 105-a. In some examples, the OFDM scheme may be associated with uniformly-distributed constellation symbols that each have a same length and a same transmission energy. However, generating uniformly-distributed constellation symbols may be inefficient, which may lead to increased processing delays. To increase efficiency of the wireless communications system, the UE 115-a may implement amplitude shaping for various coded modulation schemes in communicating with the network entity 105-a. For example, the UE 115-a and the network entity 105-a may communicate using probability shaping. The probability shaping may be associated with a non-uniform distribution of each constellation symbol amplitude being selected, which may improve the reliability and efficiency of the wireless communications system. In some examples, a Maxwell-Boltzman (MB) distribution may be utilized as a target distribution for the probability shaping operations. The MB distribution may be defined on the symbol level and may assign higher probability to symbols of lower power, according to the following equation:

$${( p ( x ) \sim e )}^{- v {\vert x \vert}^{2}}$$

Where v may be an example of velocity, and x may be an example of a point in time. The UE 115-a may use the MB distribution to shape all amplitude bit levels of the symbol sequence 210.

In some examples, a probability shaping technique where sign bits are kept uniform may be used. For example, the PAS scheme may allow the UE 115-a to shape amplitude bits while keeping sign bits unshaped. The use of such a PAS may allow a transmitting wireless device to perform shaping operations prior to performing FEC operations. For example, the use of PAS may allow for shaping of bits to remain after FEC operations are performed on the bits (e.g., in the case that the FEC may be example of a systematic code, such as a systematic LDPC). However, in some cases, using a non-equal distribution of each constellation symbol amplitude across a transmission may be computationally complex, which may increase inefficiency of the wireless communications system 200. For example, in the case that transmission of the symbol sequence 210 may be associated with multiple layers, the UE 115-a implementing PAS on each layer may be inefficient.

To increase efficiency of modulated communications within the wireless communications system 200, a transmitting wireless device may perform one or more PAS operations on multiple portions of a message such that one or more symbols of the transmission may be associated with one or more non-uniform amplitude distributions (e.g., the shaped bits 215-a, the shaped bits 215-b), while also using uniformly distributed constellation symbols for the remaining portions of the same message (e.g., the unshaped bits 220). For example, the UE 115-a may obtain one or more subsets of bits. The UE 115-a may perform a first shaping operation on a first subset of the one or more subsets in accordance with a first PAS to generate the shaped bits 215-a, may perform a second shaping operation on a second subset of the one or more subsets in accordance with a second PAS to generate the shaped bits 215-b, and may refrain from performing a shaping operation on the remaining subsets such that one or more subsets of the unshaped bits 220 may remain. In some examples, the UE 115-a may perform a first shaping operation according to a first probability distribution on a subset of bits to generate the shaped bits 215-a and may perform a second shaping operation according to a second probability distribution on a second subset of bits to generate the shaped bits 215-b. The UE 115-a may map each subset of bits (e.g., both the shaped bits 215 and the unshaped bits 220) to the symbol sequence 210, and may transmit the symbol sequence 210 to the network entity 105-a.

In some examples, the UE 115-a and the network entity 105-a may communicate various parameters. For example, the network entity 105-a may transmit the control signaling 205 to the UE 151-a. For example, prior to the UE 115-a performing shaping operations, the network entity 105-a may transmit, and the UE 115-a may receive, the control signaling 205 indicating various parameters. In some examples, the parameters may include an indication of an interleaving configuration. The UE 115-a may receive the indication of the interleaving configuration and may perform an interleaving operation on the symbols of the symbol sequence 210 prior to transmitting the symbol sequence 210 to the network entity 105-a. In some cases, the UE 115-a may transmit the probability distribution parameter 225 to the network entity 105-a. For example, the probability distribution parameter 225 may be a parameter that links or associates the final probability distributions across the shaped bits 215-a, the shaped bits 215-b, and the unshaped bits 220 of the symbol sequence 210. The UE 115-a may transmit the probability distribution parameter 225 to the network entity 105-a for use in decoding and demodulating the symbol sequence 210.

Implementing probabilistic shaping for multiple data portions with coupled distributions for the various portions of the symbol sequence 210 may increase shaping gain while decreasing signaling overhead in the symbol sequence 210. For example, enabling a transmitting wireless device (e.g., the UE 115-a, the network entity 105-a) to determine separate probability distributions for each shaping block of a transmission may increase efficiency of the associated wireless communications system 200, decrease complexity of the wireless communications system 200, and decrease processing by the transmitting wireless device.

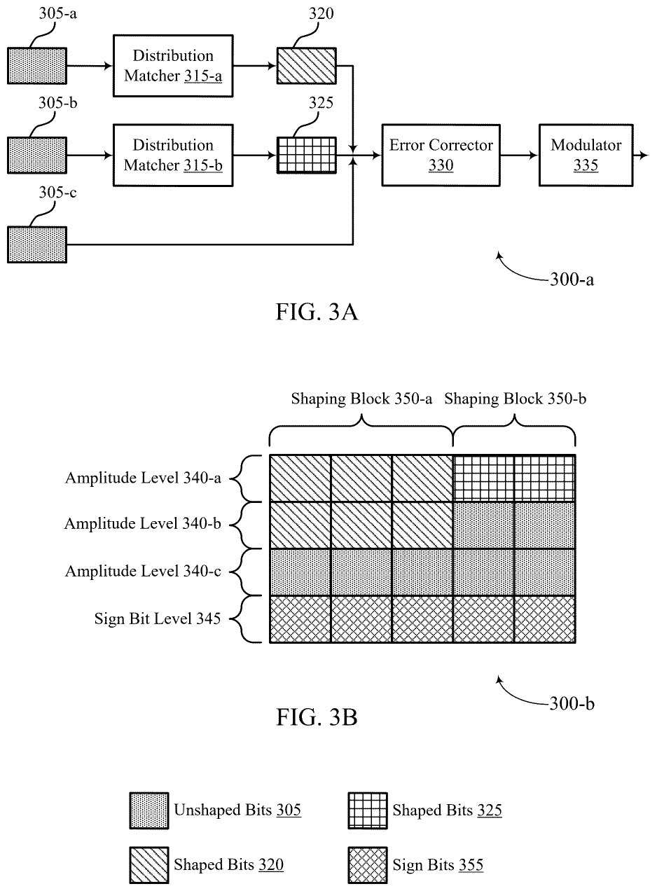

FIGS. 3A and 3B show examples of a shaping process 300-a and a shaping diagram 300-b, respectively, that support probabilistic shaping for multiple data portions with coupled distributions in accordance with one or more aspects of the present disclosure. The shaping process 300-a and the shaping diagram 300-b may include examples of or be implemented by portions of the wireless communications system 100 and the wireless communications system 200 as described with reference to FIGS. 1 and 2. For example, the shaping process 300-a may include distribution matchers 315, an error corrector 330, and a modulator 335, which may be included in a transmitting wireless device, such as a UE 115 or a network entity 105 as described with reference to FIGS. 1 and 2. The components of the shaping process 300-a may perform one or more operations on various bits (e.g., unshaped bits 305, for example) to generate the shaping diagram 300-b.

FIG. 3A illustrates an example of the shaping process 300-a that supports probabilistic shaping for multiple data portions with coupled distributions in accordance with one or more aspects of the present disclosure. For example, the various components of the shaping process 300-a may be implemented by a UE 115 (e.g., as described with reference to FIGS. 1 and 2), a network entity 105, or another transmitting wireless device prior to or as part of communicating with a receiving wireless device.

A transmitting wireless device may obtain unshaped bits 305 and perform various operations on the unshaped bits 305 prior to transmitting them to a receiving wireless device. For example, the transmitting wireless device may obtain the unshaped bits 305 which may include various subsets of bits, such as the unshaped bits 305-a, the unshaped bits 305-b, and the unshaped bits 305-c. To increase shaping gain of an associated transmission, the transmitting wireless device may shape one or more subsets of the unshaped bits 305. For example, the transmitting wireless device may input the unshaped bits 305-a into the distribution matcher 315-a and the unshaped bits 305-b into the distribution matcher 315-b. In some examples, the transmitting wireless device may refrain from inputting the unshaped bits 305-c into a distribution matcher.

The distribution matchers 315 may perform one or more shaping operations on the unshaped bits 305-a and the unshaped bits 305-b to generate the shaped bits 320 and the shaped bits 325, respectively. The distribution matchers 315 may perform the shaping operations according to one or more equations. For example, the distribution matchers 315 may perform shaping operations according to the following equation:

$${{p}_{i} ( {S}_{i} ) \sim e )}^{\frac{v}{{2}^{L - {L}_{i}}} {\sum }_{{u}_{i} ∈ {\{ 0 , 1 \}}^{L - {L}_{i}}} {f ( {S}_{i} , {U}_{i} = {u}_{i} )}^{2}}$$

Where ƒ may be an example of a real modulation mapping function, Sᵢ may be an example of a sequence of Lᵢ bits to be shaped (e.g., the unshaped bits 305-a and the unshaped bits 305-b, for example), Uᵢ may be an example of a sequence of uniformly distributed bits (e.g., the unshaped bits 305-c), and v may be an example of a probability distribution parameter that may be associated with a final probability distributions all subsets of bits of the final symbol sequence. The real modulation mapping function ƒ may be characterized according to

$$f : {\{ 0 , 1 \}}^{L} ↦ \{ 1 , 3 , 5 , … , {2}^{L + 1} - 1 \}$$

and may map Lᵢ bits [b₁, b₂, . . . , b_{L}] to an amplitude level (e.g., a positive real number). Sᵢ may be an example of a sequence of bits to be shaped, such as (b₁, b₂, . . . , b_{L}_{ᵢ}). Uᵢ may be an example of a sequence of uniformly distributed bits, such as (b_{L}_{ᵢ}₊₁, b_{L}_{ᵢ}₊₂, . . . , b_{L}) according to the sequence of L-Lᵢ bits that are uniformly distributed. Both of the distribution matchers 315 may perform shaping operations according to pᵢ(Sᵢ) for subsets i=1, 2, . . . and so on. For example, the distribution matcher 315-a may perform shaping operations on the unshaped bits 305-a using i=1, and the distribution matcher 315-b may perform shaping operations on the unshaped bits 305-b using i=2.

Along with being associated (e.g., dependent on) variables, pᵢ(Sᵢ) may be associated with (e.g., based on) energy of the subsets of bits. For example, the distribution matchers 315 may perform shaping operations on the unshaped bits 305-a and the unshaped bits 305-b according to the following probability mass function (PMF) equation:

$${{min}_{{p}_{i} ( {S}_{i} ) , i = 1 , 2 , …}}_{s . t . {Σ}_{i} {ρ}_{i} {H}_{{p}_{i}} ( {S}_{i} ) \geq η , η ∈ [ 0 , K ]} {\sum }_{i} {ρ}_{i} {E}_{{p}_{i} , {u}_{i}} [ {f ( {S}_{i} , {U}_{i} )}^{2} ]$$

where K may represent a largest bit amplitude level across each of the subsets of bits (e.g., across different shaping blocks), Eₚ_{ᵢ}_{,u}_{ᵢ}[ƒ(Sᵢ, Uᵢ)²] may be computed with respect to the product distribution pᵢ(Sᵢ)uᵢ(Uᵢ) where uᵢ(Uᵢ) denotes the uniform distribution, and ρᵢ may be a ratio of a quantity of transmitted symbols in a subset of bits i over a total quantity of transmitted symbols associated with all subsets of bits. The parameter v may be computed according to:

$${\sum }_{i} {ρ}_{i} {H}_{{p}_{i}} ( {S}_{i} ) = η$$

A proof of the above PMF equation is as follows:

$${{{min}_{{p}_{i} ( {S}_{i} ) , i = 1 , 2 , …}}_{s . t . {Σ}_{i} {ρ}_{i} {H}_{{p}_{i}} ( {S}_{i} ) \geq η , η ∈ [ 0 , K ]}}_{{Σ}_{{s}_{i}} {p}_{i} ( {s}_{i} ) = 1 for i = 1 , 2 , …} {\sum }_{i} {ρ}_{i} {E}_{{p}_{i} , {u}_{i}} [ {f ( {S}_{i} , {U}_{i} )}^{2} ]$$

By the method of Lagrange multipliers, we can minimize the equation:

$${\sum }_{i} {ρ}_{i} {E}_{{p}_{i} , {u}_{i}} [ {f ( {S}_{i} , {U}_{i} )}^{2} ] + λ ( η - {\sum }_{i} {ρ}_{i} {H}_{{p}_{i}} ( {S}_{i} ) ) + {\sum }_{i} {γ}_{i} ( 1 - {\sum }_{{s}_{i}} {p}_{i} ( {s}_{i} ) ) \text{(*} ) W log$$

where Sᵢ=(b₁, b₂, . . . , b_{L}_{ᵢ}) and Uᵢ=(b_{L}_{ᵢ}₊₁, b_{L}_{ᵢ}₊₂, . . . , b_{L}), L is the total quantity of amplitude levels and is equivalent to log₂(M)−1, where M is the modulation order (M-QAM). Also:

$${E}_{{p}_{i} , {u}_{i}} [ {f ( {S}_{i} , {U}_{i} )}^{2} ] = {\sum }_{{b}_{1} , {b}_{2} , … , {b}_{L}} {ρ}_{i} {p}_{i} ( {b}_{1} , {b}_{2} , . , {b}_{{L}_{i}} ) {2}^{- ( L - {L}_{i} )} {f ( {b}_{1} , {b}_{2} , … , {b}_{L} )}^{2}$$

$$and :$$

$${H}_{{p}_{i}} ( {S}_{i} ) = {\sum }_{{b}_{1} , {b}_{2} , … , {b}_{{L}_{i}}} {p}_{i} ( {b}_{1} , {b}_{2} , . , {b}_{{L}_{i}} ) log \frac{1}{{p}_{i} ( {b}_{1} , {b}_{2} , . , {b}_{{L}_{i}} )}$$

### Taking

$$\frac{\partial }{\partial {p}_{i} ( {b}_{1} , {b}_{2} , . , {b}_{{L}_{i}} )}$$

of (*) (see above) and applying a Karush-Kuhn-Tucker (KKT) condition may give:

$${\sum }_{{b}_{{L}_{i} + 1} , {b}_{{L}_{i} + 2} , … , {b}_{L}} {ρ}_{i} {2}^{- ( L - {L}_{i} )} {f ( {b}_{1} , {b}_{2} , … , {b}_{L} )}^{2} - {λρ}_{i} log \frac{1}{{p}_{i} ( {b}_{1} , {b}_{2} , . , {b}_{{L}_{i}} )} + {λρ}_{i} - {γ}_{i} = 0 \to log \frac{1}{{p}_{i} ( {b}_{1} , {b}_{2} , . , {b}_{{L}_{i}} )} ∝ \frac{1}{λ} \frac{1}{{2}^{( L - {L}_{i} )}} {\sum }_{{b}_{{L}_{i} + 1} , {b}_{{L}_{i} + 2} , … , {b}_{L}} {f ( {b}_{1} , {b}_{2} , … , {b}_{L} )}^{2}$$

where:

$${\sum }_{{b}_{1} , {b}_{2} , … , {b}_{{L}_{i}}} {p}_{i} ( {b}_{1} , {b}_{2} , . , {b}_{{L}_{i}} ) = 1$$

$${\sum }_{i} {ρ}_{i} {H}_{{p}_{i}} ( {S}_{i} ) = η$$

$$log \frac{1}{{p}_{i} ( {b}_{1} , {b}_{2} , . , {b}_{{L}_{i}} )} ∝ \frac{1}{λ} \frac{1}{{2}^{( L - {L}_{i} )}} {\sum }_{{b}_{{L}_{i} + 1} , {b}_{{L}_{i} + 2} , … , {b}_{L}} {f ( {b}_{1} , {b}_{2 ,} … , {b}_{L} )}^{2}$$

$${\sum }_{{b}_{1} , {b}_{2} , … , {b}_{{L}_{i}}} {p}_{i} ( {b}_{1} , {b}_{2} , . , {b}_{{L}_{i}} ) = 1$$

$${\sum }_{i} {ρ}_{i} {H}_{{p}_{i}} ( {S}_{i} ) = η$$

where

$$v = \frac{1}{λ}$$

completes the proof (e.g., notice that the v parameter (or λ) is determined by the condition Σᵢ ρᵢ Hₚ_{ᵢ}(Sᵢ)=η).

The distribution matchers 315 may perform different shaping operations on each subset of the unshaped bits 305 (e.g., each of the unshaped bits 305-a and the unshaped bits 305-b). For example, the distribution matcher 315-a may perform a first shaping operation on the unshaped bits 305-a according to

$$p ( {b}_{1} , {b}_{2} ) ∼ {e}^{- {vf ( {b}_{1} , {b}_{2} )}^{2}}$$

and the distribution matcher 315-b may perform a first shaping operation on the unshaped bits 305-b according to

$$q ( {b}_{1} ) ∼ {e}^{- \frac{v}{2} {Σ}_{u ∈ \{ 0 , 1 \}} {f ( {b}_{1} , u )}^{2}}$$

where the real modulation mapping function ƒ maps 2 bits [b₁, b₂] to a positive real amplitude level. For example:

$$f ( {b}_{1} , {b}_{2} ) ∈ \{ 1 , 3 , 5 , 7 \}$$

The distribution matchers 315 may perform different shaping operations on each of the unshaped bits 305-a and the unshaped bits 305-b such that the resulting shaped bits 320 and the shaped bits 325 may be associated with a different quantity of shaped amplitude bit layers.

Along with being associated (e.g., dependent on) variables, p(b₁, b₂) and q(b₁) may be associated with (e.g., based on) energy of the subsets of bits. For example, the distribution matchers 315 may perform shaping operations on the unshaped bits 305-a and the unshaped bits 305-b according to the following PMF equation:

$${{min}_{p ( {b}_{1} , {b}_{2} ) , q ( {b}_{1} )}}_{s . t . {ρH}_{p} ( {B}_{1} , {B}_{2} ) + ( 1 - 1 ρ ) {H}_{q} ( {B}_{1} ) \geq η , η ∈ [ 0 , 2 ]} {ρE}_{p} [ {f ( {B}_{1} , {B}_{2} )}^{2} ] + ( 1 - ρ ) {E}_{q , u} [ {f ( {B}_{1} , {B}_{2} )}^{2} ]$$

where E_{q,u}[ƒ(B₁, B₂)²] may be computed with respect to the product distribution q(b₁)u(b₂), where u(b₂) denotes the uniform distribution, where ρ is the ratio of the quantity of transmitted symbols associated with the subsets of shaped bits (e.g., the shaped bits 320, the shaped bits 325). In some examples, the above PMF equation may be an example of a conditional distribution that may decrease the average energy E[|ƒ(b₁, b₂)|²] as averaged over the shaped bits 320 and the shaped bits 325, under a constraint on the mixed source entropy ρHₚ(B₁, B₂)+(1−ρ)H_{q}(B₁). The parameter v may be associated with the PMF according to:

$$ρ {H}_{p} ( {B}_{1} , {B}_{2} ) + ( 1 - ρ ) {H}_{q} ( {B}_{1} ) = η$$

In some examples, the distribution matchers 315 may perform a single, partial shaping operation across a shaping block (e.g., across both the unshaped bits 305-a and the unshaped bits 305-b, on one of either the unshaped bits 305-a or the unshaped bits 305-b). For example, the transmitting wireless device may determine that it may be beneficial for each modulation symbol to be associated with a same quantity of shaped bit amplitude levels, where the quantity may be smaller than the total number of amplitude bits per modulation symbol. In the case that there may be L amplitude levels for the transmission (e.g., for the PAM, for a half of QAM) constellation, it may be beneficial to shape L′<L levels such that there may not be uneven shaping across symbols. One or both of the distribution matchers 315 may be configured to perform a shaping operation across a single set of unshaped bits 305 according to the following equation:

$$p ( x ) \sim exp ( - \frac{v}{{2}^{L - {L}^{′}}} * {\sum }_{( {x}^{′} has the same {L}^{′} MSBs as x )} {\vert {x}^{′} \vert}^{2} )$$

Accordingly, each of the modulation symbols having a same L′ quantity of most significant bits (MSBs) (e.g., in the bit labeling) may be associated with a same probability, which may be determined by an average energy of all the symbols (e.g., all symbols associated with the L′ MSB quantity or value).

An error corrector 330 of the transmitting wireless device may perform an error correction operation on the subsets of bits prior to a modulator 335 modulating the subsets of bits. For example, after the distribution matchers 315 perform shaping operations on the unshaped bits 305-a and the unshaped bits 305-b, the error corrector 330 may perform error correction operations on the shaped bits 320, the shaped bits 325, and the unshaped bits 305-c. In some examples, the error corrector 330 may be associated with FEC operations. After the error corrector 330 performs error correction operations, the shaped bits 320, the shaped bits 325, and the unshaped bits 305-c may be sent to the modulator 335. In some examples, the modulator 335 may map the shaped bits 320 and the shaped bits 325 to amplitude levels of the symbol sequence, and may map the unshaped bits 305-c and sign bits 355 to a sign bit level of the symbol sequence. In some other examples, the modulator 335 may map the shaped bits 320, the shaped bits 325, and the unshaped bits 305-c to amplitude levels of the symbol sequence, and may map the sign bits to a sign bit level of the symbol sequence. The subsets of the data may have differing quantities of shaped amplitude bits per symbols.

In some examples, the transmitting wireless device may perform an interleaving operation on the symbol sequence. For example, to avoid a possible jump in average symbol power within different subsets of shaped bits (e.g., between the shaped bits 320 and the shaped bits 325), the transmitting wireless device may apply interleaving on each of the symbols associated with the shaped bits. The transmitting wireless device may perform the interleaving operations according to interleaving parameters indicated in control signaling, as pre-configured at the wireless device, or both. The parameters may include a quantity of symbols to be transmitted, payload information, code rate information, MCS/PAS parameters, a quantity of shaping blocks, or a combination thereof.

The transmitting wireless device may transmit the symbol sequence. For example, in response to matching distributions, correcting errors, and modulating the subsets of bits of the symbol sequence, the transmitting wireless device may communicate the symbol sequence to a receiving wireless device. In some examples, the transmitting wireless device may also transmit the probability distribution parameter (e.g., v, as discussed herein) to the receiving wireless device. In some examples, the probability distribution parameter may be the only parameter required by the receiving wireless device for decoding and modulation operations. The receiving wireless device may receive the symbol sequence and the probability distribution parameter and may use the probability distribution parameter in demodulating and decoding the symbol sequence.

FIG. 3B illustrates an example of the shaping diagram 300-b that supports probabilistic shaping for multiple data portions with coupled distributions in accordance with one or more aspects of the present disclosure. For example, the shaping diagram 300-b may be an example of a shaping layout including various subsets of bits, as described herein with reference to the shaping process 300-a. For example, the shaping diagram 300-b may include a shaping block 350-a and a shaping block 350-b.

The shaping block 350-a may include an example of a first set of bits where a subset of the bits have been shaped (e.g., the shaped bits 320) and a subset of the bits have not been shaped (e.g., the unshaped bits 305, the sign bits 355). The subset of bits associated with an amplitude level 340-a and an amplitude level 340-b of the shaping block 350-a may be shaped (e.g., may include the shaped bits 320), while subsets of bits associated with an amplitude level 340-c and a sign bit level 345 may not be shaped (e.g., the unshaped bits 305 and the sign bits 355, respectively).

The shaping block 350-b may include an example of a second set of bits where a subset of the bits have been shaped (e.g., the shaped bits 325) and a subset of the bits have not been shaped (e.g., the unshaped bits 305, the sign bits 355). The subset of bits associated with an amplitude level 340-a of the shaping block 350-b may be shaped (e.g., may include the shaped bits 325), while subsets of bits associated with an amplitude level 340-b, an amplitude level 340-c, and a sign bit level 345 may not be shaped (e.g., the unshaped bits 305 and the sign bits 355, respectively).

Enabling the transmitting wireless device (e.g., the UE 115-a, the network entity 105-a) to determine separate probability distributions for each shaping block 350 of a transmission may increase efficiency of the transmitting and receiving wireless devices, decrease complexity of the wireless devices, and decrease processing by the transmitting wireless device.

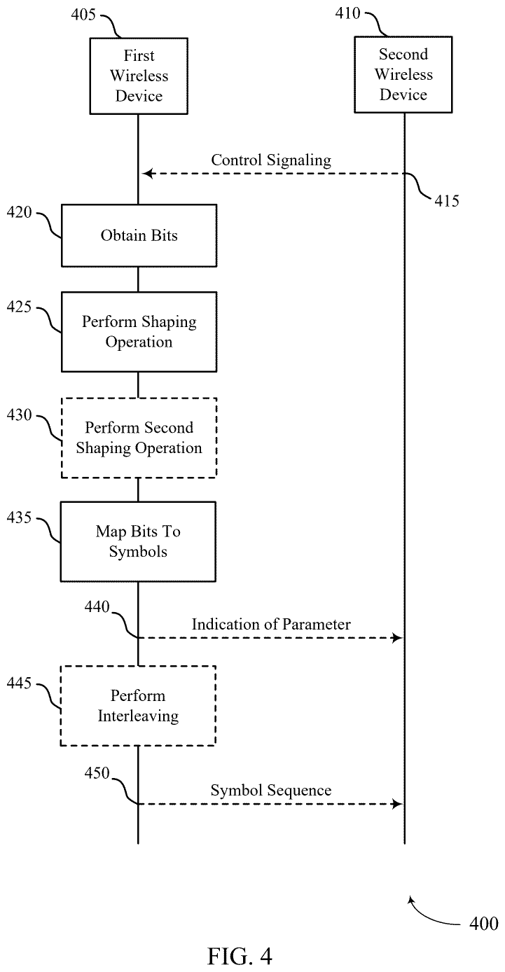

FIG. 4 shows an example of a process flow 400 that supports probabilistic shaping for multiple data portions with coupled distributions in accordance with one or more aspects of the present disclosure. Aspects of the process flow 400 may implement, or be implemented by, aspects of the wireless communications system 100. For example, the process flow 400 illustrates various signals and operations that enable probabilistic shaping for multiple portions (e.g., subsets of data) of a same data transmission. The process flow 400 includes a first wireless device 405 and a second wireless device 410, which may be examples of UEs 115, network entities 105, and other wireless devices as described with reference to FIGS. 1 and 2.

In some examples, the operations illustrated in process flow 400 may be performed by hardware (e.g., including circuitry, processing blocks, logic components, and other components), code such as processor-executable code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 415, the second wireless device 410 may transmit, and the first wireless device 405 may receive, control signaling. The control signaling may include information to be used in future communications between the first wireless device 405 and the second wireless device 410. For example, the control signaling may include an indication an interleaving configuration. In some examples, the indication of the interleaving configuration may be an example of one or more parameters associated with the interleaving configuration.

At 420, the first wireless device 405 may obtain one or more data bits. For example, the first wireless device 405 may obtain (e.g., receive, determine, calculate, access) one or more subsets of data bits. In some examples, each subset of data bits may be associated with a uniform information bit distribution (e.g., a uniform probability distribution), may be unshaped, or a combination thereof.

At 425, the first wireless device 405 may perform a first shaping operation. For example, the first wireless device 405 may perform a first shaping operation on a first subset of bits of the obtained subsets of bits. The first wireless device 405 may perform the first shaping operation on the first subset of bits according to a first probability distribution. The first wireless device 405 may perform the first shaping operation according to one or more parameters associated with the first probability distribution. For example, the first wireless device 405 may perform the first shaping operation according to a first parameter, which may be associated with a final probability distribution (e.g., the first probability distribution, a second probability distribution) across all subsets of bits of the transmission.

At 430, the first wireless device 405 may also perform a second shaping operation. For example, in addition to performing the first shaping operation on a first subset of bits, the first wireless device 405 may also perform a second shaping operation on a second subset of bits. As such, the first wireless device 405 may perform the first shaping operation on the first subset of bits according to an equation (e.g., a second equation) associated with the first parameter associated with the final probability distribution, the fourth parameter of the plurality of parameters associated with a modulation mapping function, and one or more other parameters as described herein. The first wireless device 405 may also perform a second shaping operation on a second subset of bits according to a second probability distribution different from the first probability distribution associated with the first shaped bits. The third equation may be associated with the first parameter associated with the final probability distribution, the second parameter associated with the uniform information bit distribution of the original subsets of bits, and one or more other parameters as described herein.

In some examples, the first probability distribution and the second probability distribution may be based on one or more equations associated with the parameters. For example, the first wireless device 405 may perform the shaping operations according to a first equation. The first equation may be associated with (e.g., include) variables such as the first parameter associated with the final probability distribution across both shaped subsets, a second parameter associated with the uniform information bit distribution of the unshaped bits, a third parameter associated with a symbol sequence, and a fourth parameter of the plurality of parameters associated with a modulation mapping function. The first equation may also be associated with one or more other parameters, as described further herein.

At 435, the first wireless device 405 may map one or more bits to symbols. For example, the first wireless device 405 may map the shaped first subset of bits, the shaped second subset of bits, and one or more subsets of unshaped bits to one or more symbols of a symbol sequence. In some examples, the first wireless device 405 may map one or more (e.g., multiple) subsets of shaped bits and one or more subsets (e.g., remaining subsets) of unshaped bits to symbols. For example, to map the subsets of bits to the symbols, the first wireless device 405 may map one or more subsets of shaped bits to one or more first symbols and a subset of unshaped bits to one or more second symbols. The one or more first symbols and the one or more second symbols may be associated with different probabilities (e.g., the first probability distribution, the second probability distribution) that may each be based on various parameters and an average energy of the associated symbols. Additionally, or alternatively, the first wireless device 405 may map a single quantity of the shaped bits to a quantity of symbols that may be less than a total quantity of available symbols. In some examples, a quantity of the first subset of bits mapped to the symbols may be different from a quantity of the second subset of bits mapped to the symbols.

At 440, the first wireless device 405 may transmit, and the second wireless device 410 may receive, an indication of one or more parameters. For example, based on mapping the subsets of buts to the symbols, the first wireless device 405 may transmit an indication of the first parameter associated with the final probability distribution (e.g., including the first probability distribution and the second probability distribution) to the second wireless device 410 for use in demodulation of the symbol sequence.

At 445, in some examples, the first wireless device 405 may perform one or more interleaving operations. For example, the first wireless device 405 may perform an interleaving operation on the one or more symbols of the symbol sequence according to an interleaving configuration. In some examples, the interleaving configuration may be configured by the control signaling (e.g., received at 415), may be based on one or more parameters associated with the interleaving configuration, or a combination thereof.

At 450, the first wireless device 405 may transmit, and the second wireless device 410 may receive, the symbol sequence. For example, in response to mapping the subsets of bits to the one or more symbols, performing the interleaving operation, or both, the first wireless device 405 may transmit the sequence of symbols to the second wireless device 410.

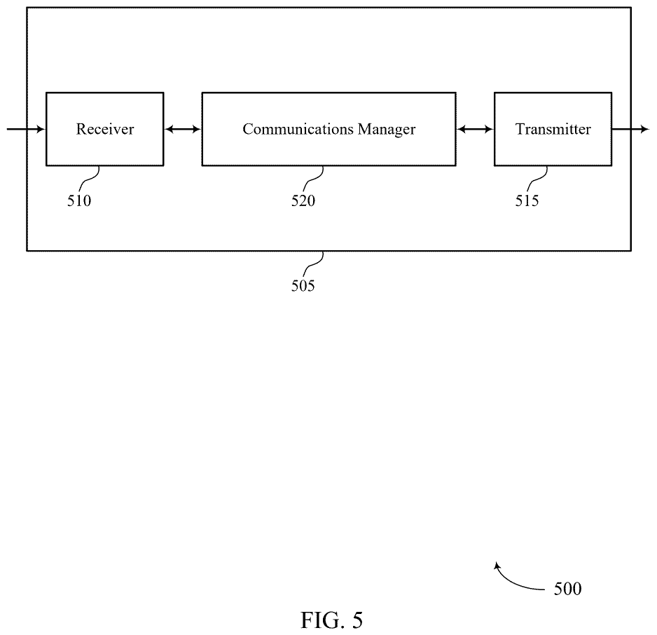

FIG. 5 shows a block diagram 500 of a device 505 that supports probabilistic shaping for multiple data portions with coupled distributions in accordance with one or more aspects of the present disclosure. The device 505 may be an example of aspects of a wireless device as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to probabilistic shaping for multiple data portions with coupled distributions). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to probabilistic shaping for multiple data portions with coupled distributions). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of probabilistic shaping for multiple data portions with coupled distributions as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for obtaining one or more subsets of bits. The communications manager 520 is capable of, configured to, or operable to support a means for performing both a first shaping operation on a first subset of bits of the one or more subsets of bits in accordance with a first probability distribution and a second shaping operation on a second subset of bits of the one or more subsets of bits in accordance with a second probability distribution different from the first probability distribution, where the first shaping operation and the second shaping operation utilize a same set of shaping parameters. The communications manager 520 is capable of, configured to, or operable to support a means for mapping the shaped first subset of bits and the shaped second subset of bits to one or more symbols of a symbol sequence. The communications manager 520 is capable of, configured to, or operable to support a means for transmitting, to a second wireless device, the symbol sequence based on mapping the shaped first subset of bits and the shaped second subset of bits to the one or more symbols.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced processing, reduced power consumption, and more efficient utilization of communication resources.

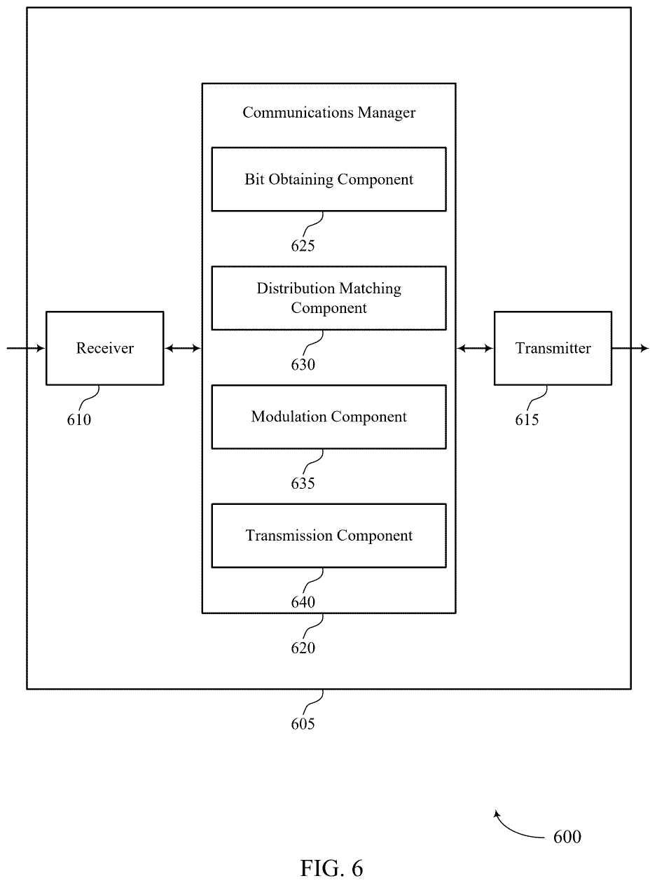

FIG. 6 shows a block diagram 600 of a device 605 that supports probabilistic shaping for multiple data portions with coupled distributions in accordance with one or more aspects of the present disclosure. The device 605 may be an example of aspects of a device 505 or a wireless device 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to probabilistic shaping for multiple data portions with coupled distributions). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to probabilistic shaping for multiple data portions with coupled distributions). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of probabilistic shaping for multiple data portions with coupled distributions as described herein. For example, the communications manager 620 may include a bit obtaining component 625, a distribution matching component 630, a modulation component 635, a transmission component 640, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The bit obtaining component 625 is capable of, configured to, or operable to support a means for obtaining one or more subsets of bits. The distribution matching component 630 is capable of, configured to, or operable to support a means for performing both a first shaping operation on a first subset of bits of the one or more subsets of bits in accordance with a first probability distribution and a second shaping operation on a second subset of bits of the one or more subsets of bits in accordance with a second probability distribution different from the first probability distribution, where the first shaping operation and the second shaping operation utilize a same set of shaping parameters. The modulation component 635 is capable of, configured to, or operable to support a means for mapping the shaped first subset of bits and the shaped second subset of bits to one or more symbols of a symbol sequence. The transmission component 640 is capable of, configured to, or operable to support a means for transmitting, to a second wireless device, the symbol sequence based on mapping the shaped first subset of bits and the shaped second subset of bits to the one or more symbols.

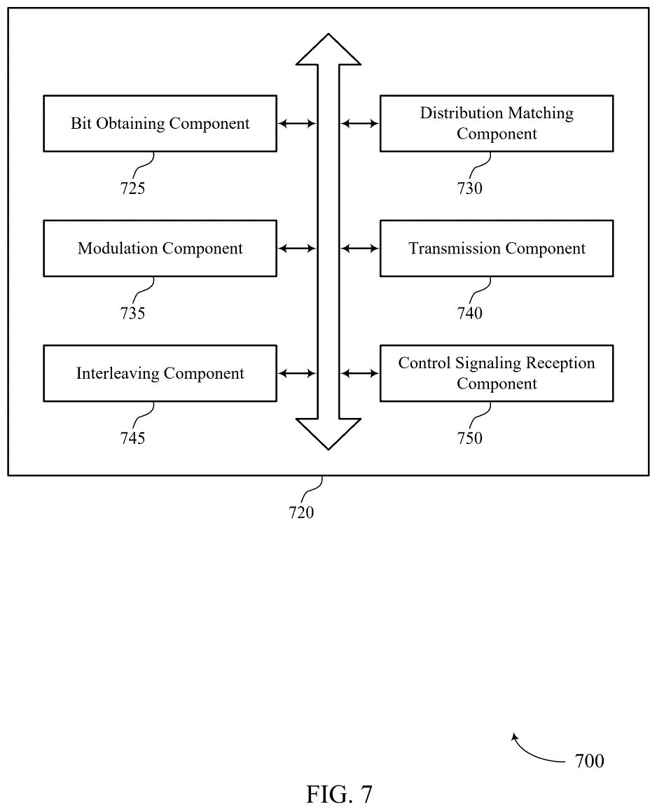

FIG. 7 shows a block diagram 700 of a communications manager 720 that supports probabilistic shaping for multiple data portions with coupled distributions in accordance with one or more aspects of the present disclosure. The communications manager 720 may be an example of aspects of a communications manager 520, a communications manager 620, or both, as described herein. The communications manager 720, or various components thereof, may be an example of means for performing various aspects of probabilistic shaping for multiple data portions with coupled distributions as described herein. For example, the communications manager 720 may include a bit obtaining component 725, a distribution matching component 730, a modulation component 735, a transmission component 740, an interleaving component 745, a control signaling reception component 750, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The bit obtaining component 725 is capable of, configured to, or operable to support a means for obtaining one or more subsets of bits. The distribution matching component 730 is capable of, configured to, or operable to support a means for performing both a first shaping operation on a first subset of bits of the one or more subsets of bits in accordance with a first probability distribution and a second shaping operation on a second subset of bits of the one or more subsets of bits in accordance with a second probability distribution different from the first probability distribution, where the first shaping operation and the second shaping operation utilize a same set of shaping parameters. The modulation component 735 is capable of, configured to, or operable to support a means for mapping the shaped first subset of bits and the shaped second subset of bits to one or more symbols of a symbol sequence. The transmission component 740 is capable of, configured to, or operable to support a means for transmitting, to a second wireless device, the symbol sequence based on mapping the shaped first subset of bits and the shaped second subset of bits to the one or more symbols.

In some examples, to support performing the shaping operation, the distribution matching component 730 is capable of, configured to, or operable to support a means for performing the first shaping operation on the first subset of bits and the second shaping operation on the second subset of bits according to a first parameter of the set of shaping parameters, the first parameter of the set of shaping parameters associated with the first probability distribution and the second probability distribution.

In some examples, the transmission component 740 is capable of, configured to, or operable to support a means for transmitting, to the second wireless device, an indication of the first parameter of the set of shaping parameters for use in demodulation of the symbol sequence based on mapping the shaped first subset of bits and the shaped second subset of bits to the one or more symbols.

In some examples, to support mapping the shaped first subset of bits and the shaped second subset of bits to the one or more symbols of the symbol sequence, the modulation component 735 is capable of, configured to, or operable to support a means for mapping the shaped first subset of bits to one or more first symbols of the one or more symbols, where the one or more first symbols are associated with a first probability, the first probability based on the first parameter and an average energy of the one or more first symbols. In some examples, to support mapping the shaped first subset of bits and the shaped second subset of bits to the one or more symbols of the symbol sequence, the modulation component 735 is capable of, configured to, or operable to support a means for mapping the shaped second subset of bits to one or more second symbols of the one or more symbols, where the one or more second symbols are associated with a second probability, the second probability based on the first parameter and an average energy of the one or more second symbols, and where a quantity of the shaped first subset of bits mapped to the one or more first symbols is different from a quantity of the shaped second subset of bits mapped to the one or more second symbols.

In some examples, the first probability distribution and the second probability distribution are based on one or more equations associated with one or more parameters of the set of shaping parameters.

In some examples, to support performing both the first shaping operation and the second shaping operation, the distribution matching component 730 is capable of, configured to, or operable to support a means for performing the first shaping operation on the first subset of bits and the second shaping operation on the second subset of bits according to a first equation of the one or more equations, where the first equation is associated with at least: a first parameter of the set of shaping parameters associated with the first probability distribution and the second probability distribution; a second parameter of the set of shaping parameters associated with a uniform information bit distribution; a third parameter of the set of shaping parameters associated with the symbol sequence; and a fourth parameter of the set of shaping parameters associated with a modulation mapping function.

In some examples, the distribution matching component 730 is capable of, configured to, or operable to support a means for performing the first shaping operation on the first subset of bits according to a second equation of the one or more equations, where the second equation is associated with at least: a first parameter of the set of shaping parameters associated with the first probability distribution and the second probability distribution; and a second parameter of the set of shaping parameters associated with a modulation mapping function. In some examples, the distribution matching component 730 is capable of, configured to, or operable to support a means for performing the second shaping operation on the second subset of bits according to a third equation of the one or more equations, where the third equation is associated with at least: the first parameter of the set of shaping parameters; and a third parameter of the set of shaping parameters associated with a uniform information bit distribution.

In some examples, the interleaving component 745 is capable of, configured to, or operable to support a means for performing an interleaving operation on the one or more symbols of the symbol sequence according to an interleaving configuration, where transmitting the symbol sequence is based on performing the interleaving operation.

In some examples, the control signaling reception component 750 is capable of, configured to, or operable to support a means for receiving control signaling including an indication of the interleaving configuration, where performing the interleaving operation on the one or more symbols of the symbol sequence is based on one or more parameters associated with the indication of the interleaving configuration.

In some examples, to support mapping the shaped first subset of bits and the shaped second subset of bits of the one or more subsets of bits to the one or more symbols of the symbol sequence, the modulation component 735 is capable of, configured to, or operable to support a means for mapping a quantity of bits of the shaped first subset of bits and the shaped second subset of bits to a quantity of symbols of the symbol sequence according to the first probability distribution and the second probability distribution, where the quantity of bits is less than the quantity of symbols.

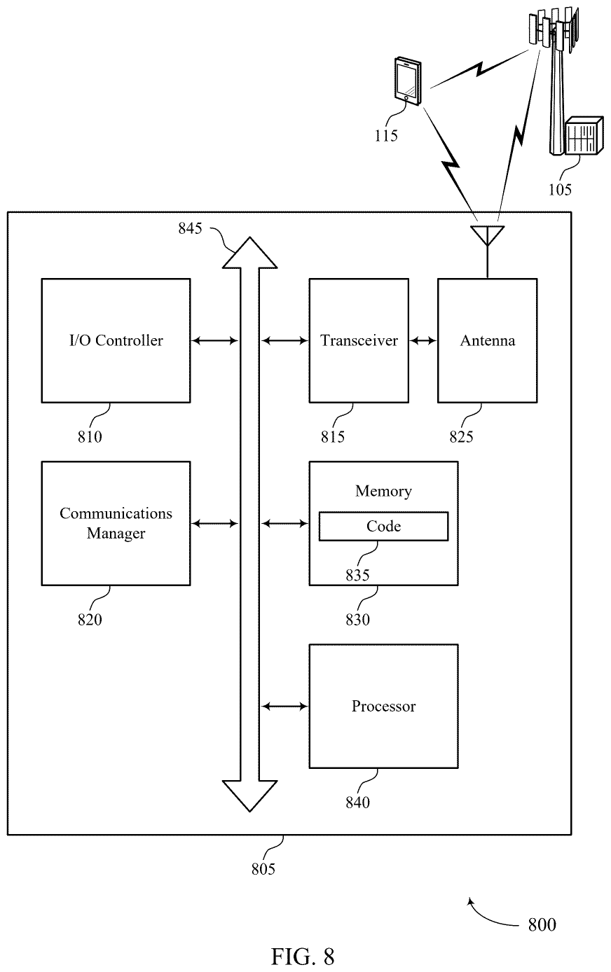

FIG. 8 shows a diagram of a system 800 including a device 805 that supports probabilistic shaping for multiple data portions with coupled distributions in accordance with one or more aspects of the present disclosure. The device 805 may be an example of or include components of a device 505, a device 605, or a wireless device as described herein. The device 805 may include components for bi-directional voice and data communications including components for transmitting and receiving communications, such as a communications manager 820, an I/O controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include RAM and ROM. The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a BIOS which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting probabilistic shaping for multiple data portions with coupled distributions). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for obtaining one or more subsets of bits. The communications manager 820 is capable of, configured to, or operable to support a means for performing both a first shaping operation on a first subset of bits of the one or more subsets of bits in accordance with a first probability distribution and a second shaping operation on a second subset of bits of the one or more subsets of bits in accordance with a second probability distribution different from the first probability distribution, where the first shaping operation and the second shaping operation utilize a same set of shaping parameters. The communications manager 820 is capable of, configured to, or operable to support a means for mapping the shaped first subset of bits and the shaped second subset of bits to one or more symbols of a symbol sequence. The communications manager 820 is capable of, configured to, or operable to support a means for transmitting, to a second wireless device, the symbol sequence based on mapping the shaped first subset of bits and the shaped second subset of bits to the one or more symbols.

By including or configuring the communications manager 820 in accordance with examples as described herein, the device 805 may support techniques for reduced latency, reduced power consumption, more efficient utilization of communication resources, and improved coordination between devices.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of probabilistic shaping for multiple data portions with coupled distributions as described herein, or the at least one processor 840 and the at least one memory 830 may be otherwise configured to, individually or collectively, perform or support such operations.

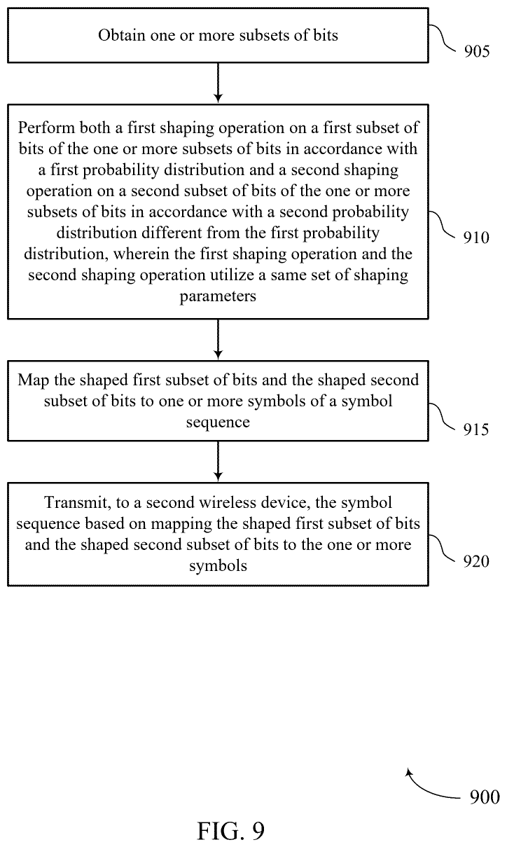

FIG. 9 shows a flowchart illustrating a method 900 that supports probabilistic shaping for multiple data portions with coupled distributions in accordance with one or more aspects of the present disclosure. The operations of the method 900 may be implemented by a wireless device or its components as described herein. For example, the operations of the method 900 may be performed by a wireless device as described with reference to FIGS. 1 through 8. In some examples, a wireless device may execute a set of instructions to control the functional elements of the wireless device to perform the described functions. Additionally, or alternatively, the wireless device may perform aspects of the described functions using special-purpose hardware.

At 905, the method may include obtaining one or more subsets of bits. The operations of 905 may be performed in accordance with examples as disclosed herein. In some examples, aspects of the operations of 905 may be performed by a bit obtaining component 725 as described with reference to FIG. 7.

At 910, the method may include performing both a first shaping operation on a first subset of bits of the one or more subsets of bits in accordance with a first probability distribution and a second shaping operation on a second subset of bits of the one or more subsets of bits in accordance with a second probability distribution different from the first probability distribution, where the first shaping operation and the second shaping operation utilize a same set of shaping parameters. The operations of 910 may be performed in accordance with examples as disclosed herein. In some examples, aspects of the operations of 910 may be performed by a distribution matching component 730 as described with reference to FIG. 7.

At 915, the method may include mapping the shaped first subset of bits and the shaped second subset of bits to one or more symbols of a symbol sequence. The operations of 915 may be performed in accordance with examples as disclosed herein. In some examples, aspects of the operations of 915 may be performed by a modulation component 735 as described with reference to FIG. 7.

At 920, the method may include transmitting, to a second wireless device, the symbol sequence based on mapping the shaped first subset of bits and the shaped second subset of bits to the one or more symbols. The operations of 920 may be performed in accordance with examples as disclosed herein. In some examples, aspects of the operations of 920 may be performed by a transmission component 740 as described with reference to FIG. 7.

The following provides an overview of aspects of the present disclosure:

Aspect 1: A method for wireless communications at a wireless device, comprising: obtaining one or more subsets of bits; performing both a first shaping operation on a first subset of bits of the one or more subsets of bits in accordance with a first probability distribution and a second shaping operation on a second subset of bits of the one or more subsets of bits in accordance with a second probability distribution different from the first probability distribution, wherein the first shaping operation and the second shaping operation utilize a same set of shaping parameters; mapping the shaped first subset of bits and the shaped second subset of bits to one or more symbols of a symbol sequence; and transmitting, to a second wireless device, the symbol sequence based at least in part on mapping the shaped first subset of bits and the shaped second subset of bits to the one or more symbols.

Aspect 2: The method of aspect 1, wherein the probabilistic constellation shaping scheme is based at least in part on a plurality of parameters, wherein performing the shaping operation comprises: performing the first shaping operation on the first subset of bits and the second shaping operation on the second subset of bits according to a first parameter of the set of shaping parameters, the first parameter of the set of shaping parameters associated with the first probability distribution and the second probability distribution.

Aspect 3: The method of aspect 2, further comprising: transmitting, to the second wireless device, an indication of the first parameter of the set of shaping parameters for use in demodulation of the symbol sequence based at least in part on mapping the shaped first subset of bits and the shaped second subset of bits to the one or more symbols.

Aspect 4: The method of any of aspects 2 through 3, wherein mapping the shaped first subset of bits and the shaped second subset of bits to the one or more symbols of the symbol sequence comprises: mapping the shaped first subset of bits to one or more first symbols of the one or more symbols, wherein the one or more first symbols are associated with a first probability, the first probability based at least in part on the first parameter and an average energy of the one or more first symbols; and mapping the shaped second subset of bits to one or more second symbols of the one or more symbols, wherein the one or more second symbols are associated with a second probability, the second probability based at least in part on the first parameter and an average energy of the one or more second symbols, and wherein a quantity of the shaped first subset of bits mapped to the one or more first symbols is different from a quantity of the shaped second subset of bits mapped to the one or more second symbols.

Aspect 5: The method of any of aspects 1 through 4, wherein the first probability distribution and the second probability distribution are based at least in part on one or more equations associated with one or more parameters of the set of shaping parameters.

Aspect 6: The method of aspect 5, wherein performing both the first shaping operation and the second shaping operation comprises: performing the first shaping operation on the first subset of bits and the second shaping operation on the second subset of bits according to a first equation of the one or more equations, wherein the first equation is associated with at least: a first parameter of the set of shaping parameters associated with the first probability distribution and the second probability distribution; a second parameter of the set of shaping parameters associated with a uniform information bit distribution; a third parameter of the set of shaping parameters associated with the symbol sequence; and a fourth parameter of the set of shaping parameters associated with a modulation mapping function.

Aspect 7: The method of any of aspects 5 through 6, further comprising: performing the first shaping operation on the first subset of bits according to a second equation of the one or more equations, wherein the second equation is associated with at least: a first parameter of the set of shaping parameters associated with the first probability distribution and the second probability distribution; and a second parameter of the set of shaping parameters associated with a modulation mapping function; and performing the second shaping operation on the second subset of bits according to a third equation of the one or more equations, wherein the third equation is associated with at least: the first parameter of the set of shaping parameters; and a third parameter of the set of shaping parameters associated with a uniform information bit distribution.

Aspect 8: The method of any of aspects 1 through 7, further comprising: performing an interleaving operation on the one or more symbols of the symbol sequence according to an interleaving configuration, wherein transmitting the symbol sequence is based at least in part on performing the interleaving operation.

Aspect 9: The method of aspect 8, further comprising: receiving control signaling comprising an indication of the interleaving configuration, wherein performing the interleaving operation on the one or more symbols of the symbol sequence is based at least in part on one or more parameters associated with the indication of the interleaving configuration.

Aspect 10: The method of any of aspects 1 through 9, wherein mapping the shaped first subset of bits and the shaped second subset of bits of the one or more subsets of bits to the one or more symbols of the symbol sequence comprises: mapping a quantity of bits of the shaped first subset of bits and the shaped second subset of bits to a quantity of symbols of the symbol sequence according to the first probability distribution and the second probability distribution, wherein the quantity of bits is less than the quantity of symbols.

Aspect 11: A wireless device for wireless communications, comprising one or more memories storing processor-executable code, and one or more processors coupled with the one or more memories and individually or collectively operable to execute the code to cause the wireless device to perform a method of any of aspects 1 through 10.

Aspect 12: A wireless device for wireless communications, comprising at least one means for performing a method of any of aspects 1 through 10.

Aspect 13: A non-transitory computer-readable medium storing code for wireless communications, the code comprising instructions executable by one or more processors to perform a method of any of aspects 1 through 10.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A wireless device, comprising:
one or more memories storing processor-executable code; and
one or more processors coupled with the one or more memories and individually or collectively operable to execute the code to cause the wireless device to:
obtain one or more subsets of bits;
perform both a first shaping operation on a first subset of bits of the one or more subsets of bits in accordance with a first probability distribution and a second shaping operation on a second subset of bits of the one or more subsets of bits in accordance with a second probability distribution different from the first probability distribution, wherein the first shaping operation and the second shaping operation utilize a same set of shaping parameters;
map the shaped first subset of bits and the shaped second subset of bits to one or more symbols of a symbol sequence; and
transmit, to a second wireless device, the symbol sequence based at least in part on mapping the shaped first subset of bits and the shaped second subset of bits to the one or more symbols.

2. The wireless device of claim 1, wherein, to perform the first shaping operation and the second shaping operation, the one or more processors are individually or collectively operable to execute the code to cause the wireless device to:
perform the first shaping operation on the first subset of bits and the second shaping operation on the second subset of bits according to a first parameter of the set of shaping parameters, the first parameter of the set of shaping parameters associated with the first probability distribution and the second probability distribution.

3. The wireless device of claim 2, wherein the one or more processors are individually or collectively further operable to execute the code to cause the wireless device to:
transmit, to the second wireless device, an indication of the first parameter of the set of shaping parameters for use in demodulation of the symbol sequence based at least in part on mapping the shaped first subset of bits and the shaped second subset of bits to the one or more symbols.

4. The wireless device of claim 2, wherein, to map the shaped first subset of bits and the shaped second subset of bits to the one or more symbols of the symbol sequence, the one or more processors are individually or collectively operable to execute the code to cause the wireless device to:
map the shaped first subset of bits to one or more first symbols of the one or more symbols, wherein the one or more first symbols are associated with a first probability, the first probability based at least in part on the first parameter and an average energy of the one or more first symbols; and
map the shaped second subset of bits to one or more second symbols of the one or more symbols, wherein the one or more second symbols are associated with a second probability, the second probability based at least in part on the first parameter and an average energy of the one or more second symbols, and wherein a quantity of the shaped first subset of bits mapped to the one or more first symbols is different from a quantity of the shaped second subset of bits mapped to the one or more second symbols.

5. The wireless device of claim 1, wherein the first probability distribution and the second probability distribution are based at least in part on one or more equations associated with the one or more parameters of the set of shaping parameters.

6. The wireless device of claim 5, wherein, to perform both the first shaping operation and the second shaping operation, the one or more processors are individually or collectively operable to execute the code to cause the wireless device to:
perform the first shaping operation on the first subset of bits and the second shaping operation on the second subset of bits according to a first equation of the one or more equations, wherein the first equation is associated with at least:
a first parameter of the set of shaping parameters associated with the first probability distribution and the second probability distribution;
a second parameter of the set of shaping parameters associated with a uniform information bit distribution;
a third parameter of the set of shaping parameters associated with the symbol sequence; and
a fourth parameter of the set of shaping parameters associated with a modulation mapping function.

7. The wireless device of claim 5, wherein the one or more processors are individually or collectively further operable to execute the code to cause the wireless device to:
perform the first shaping operation on the first subset of bits according to a second equation of the one or more equations, wherein the second equation is associated with at least:
a first parameter of the set of shaping parameters associated with the first probability distribution and the second probability distribution; and
a second parameter of the set of shaping parameters associated with a modulation mapping function; and
perform the second shaping operation on the second subset of bits according to a third equation of the one or more equations, wherein the third equation is associated with at least:
the first parameter of the set of shaping parameters; and
a third parameter of the set of shaping parameters associated with a uniform information bit distribution.

8. The wireless device of claim 1, wherein the one or more processors are individually or collectively further operable to execute the code to cause the wireless device to:
perform an interleaving operation on the one or more symbols of the symbol sequence according to an interleaving configuration, wherein transmitting the symbol sequence is based at least in part on performing the interleaving operation.

9. The wireless device of claim 8, wherein the one or more processors are individually or collectively further operable to execute the code to cause the wireless device to:
receive control signaling comprising an indication of the interleaving configuration, wherein performing the interleaving operation on the one or more symbols of the symbol sequence is based at least in part on one or more parameters associated with the indication of the interleaving configuration.

10. The wireless device of claim 1, wherein, to map the shaped first subset of bits and the shaped second subset of bits to the one or more symbols of the symbol sequence, the one or more processors are individually or collectively operable to execute the code to cause the wireless device to:
map a quantity of bits of the shaped first subset of bits and the shaped second subset of bits to a quantity of symbols of the symbol sequence according to the first probability distribution and the second probability distribution, wherein the quantity of bits is less than the quantity of symbols.

11. A method for wireless communications at a wireless device, comprising:
obtaining one or more subsets of bits;
performing both a first shaping operation on a first subset of bits of the one or more subsets of bits in accordance with a first probability distribution and a second shaping operation on a second subset of bits of the one or more subsets of bits in accordance with a second probability distribution different from the first probability distribution, wherein the first shaping operation and the second shaping operation utilize a same set of shaping parameters;
mapping the shaped first subset of bits and the shaped second subset of bits to one or more symbols of a symbol sequence; and
transmitting, to a second wireless device, the symbol sequence based at least in part on mapping the shaped first subset of bits and the shaped second subset of bits to the one or more symbols.

12. The method of claim 11, wherein performing the shaping operation comprises:
performing the first shaping operation on the first subset of bits and the second shaping operation on the second subset of bits according to a first parameter of the set of shaping parameters, the first parameter of the set of shaping parameters associated with the first probability distribution and the second probability distribution.

13. The method of claim 12, further comprising:
transmitting, to the second wireless device, an indication of the first parameter of the set of shaping parameters for use in demodulation of the symbol sequence based at least in part on mapping the shaped first subset of bits and the shaped second subset of bits to the one or more symbols.

14. The method of claim 12, wherein mapping the shaped first subset of bits and the shaped second subset of bits to the one or more symbols of the symbol sequence comprises:
mapping the shaped first subset of bits to one or more first symbols of the one or more symbols, wherein the one or more first symbols are associated with a first probability, the first probability based at least in part on the first parameter and an average energy of the one or more first symbols; and
mapping the shaped second subset of bits to one or more second symbols of the one or more symbols, wherein the one or more second symbols are associated with a second probability, the second probability based at least in part on the first parameter and an average energy of the one or more second symbols, and wherein a quantity of the shaped first subset of bits mapped to the one or more first symbols is different from a quantity of the shaped second subset of bits mapped to the one or more second symbols.

15. The method of claim 11, wherein the first probability distribution and the second probability distribution are based at least in part on one or more equations associated with one or more parameters of the set of shaping parameters.

16. The method of claim 15, wherein performing both the first shaping operation and the second shaping operation comprises:
performing the first shaping operation on the first subset of bits and the second shaping operation on the second subset of bits according to a first equation of the one or more equations, wherein the first equation is associated with at least:
a first parameter of the set of shaping parameters associated with the first probability distribution and the second probability distribution;
a second parameter of the set of shaping parameters associated with a uniform information bit distribution;
a third parameter of the set of shaping parameters associated with the symbol sequence; and
a fourth parameter of the set of shaping parameters associated with a modulation mapping function.

17. The method of claim 15, further comprising:
performing the first shaping operation on the first subset of bits according to a second equation of the one or more equations, wherein the second equation is associated with at least:
a first parameter of the set of shaping parameters associated with the first probability distribution and the second probability distribution; and
a second parameter of the set of shaping parameters associated with a modulation mapping function; and
performing the second shaping operation on the second subset of bits according to a third equation of the one or more equations, wherein the third equation is associated with at least:
the first parameter of the set of shaping parameters; and
a third parameter of the set of shaping parameters associated with a uniform information bit distribution.

18. The method of claim 11, further comprising:
performing an interleaving operation on the one or more symbols of the symbol sequence according to an interleaving configuration, wherein transmitting the symbol sequence is based at least in part on performing the interleaving operation.

19. The method of claim 18, further comprising:
receiving control signaling comprising an indication of the interleaving configuration, wherein performing the interleaving operation on the one or more symbols of the symbol sequence is based at least in part on one or more parameters associated with the indication of the interleaving configuration.

20. The method of claim 11, wherein mapping the shaped first subset of bits and the shaped second subset of bits of the one or more subsets of bits to the one or more symbols of the symbol sequence comprises:
mapping a quantity of bits of the shaped first subset of bits and the shaped second subset of bits to a quantity of symbols of the symbol sequence according to the first probability distribution and the second probability distribution, wherein the quantity of bits is less than the quantity of symbols.

21. A wireless device for wireless communications, comprising:
means for obtaining one or more subsets of bits;
means for performing both a first shaping operation on a first subset of bits of the one or more subsets of bits in accordance with a first probability distribution and a second shaping operation on a second subset of bits of the one or more subsets of bits in accordance with a second probability distribution different from the first probability distribution, wherein the first shaping operation and the second shaping operation utilize a same set of shaping parameters;
means for mapping the shaped first subset of bits and the shaped second subset of bits to one or more symbols of a symbol sequence; and
means for transmitting, to a second wireless device, the symbol sequence based at least in part on mapping the shaped first subset of bits and the shaped second subset of bits to the one or more symbols.

22. The wireless device of claim 21, wherein the means for performing the shaping operation comprise:
means for performing the first shaping operation on the first subset of bits and the second shaping operation on the second subset of bits according to a first parameter of the set of shaping parameters, the first parameter of the set of shaping parameters associated with the first probability distribution and the second probability distribution.

23. The wireless device of claim 22, further comprising:
means for transmitting, to the second wireless device, an indication of the first parameter of the set of shaping parameters for use in demodulation of the symbol sequence based at least in part on mapping the shaped first subset of bits and the shaped second subset of bits to the one or more symbols.

24. The wireless device of claim 22, wherein the means for mapping the shaped first subset of bits and the shaped second subset of bits to the one or more symbols of the symbol sequence comprise:
means for mapping the shaped first subset of bits to one or more first symbols of the one or more symbols, wherein the one or more first symbols are associated with a first probability, the first probability based at least in part on the first parameter and an average energy of the one or more first symbols; and
means for mapping the shaped second subset of bits to one or more second symbols of the one or more symbols, wherein the one or more second symbols are associated with a second probability, the second probability based at least in part on the first parameter and an average energy of the one or more second symbols, and wherein a quantity of the shaped first subset of bits mapped to the one or more first symbols is different from a quantity of the shaped second subset of bits mapped to the one or more second symbols.

25. The wireless device of claim 21, wherein the first probability distribution and the second probability distribution are based at least in part on one or more equations associated with the one or more parameters of the set of shaping parameters.

26. The wireless device of claim 25, wherein the means for performing the shaping operation comprise:
means for performing the first shaping operation on the first subset of bits and the second shaping operation on the second subset of bits according to a first equation of the one or more equations, wherein the first equation is associated with at least:
a first parameter of the set of shaping parameters associated with the first probability distribution and the second probability distribution;
a second parameter of the set of shaping parameters associated with a uniform information bit distribution;
a third parameter of the set of shaping parameters associated with the symbol sequence; and
a fourth parameter of the set of shaping parameters associated with a modulation mapping function.

27. The wireless device of claim 25, further comprising:
means for performing the first shaping operation on the first subset of bits according to a second equation of the one or more equations, wherein the second equation is associated with at least:
a first parameter of the set of shaping parameters associated with the first probability distribution and the second probability distribution; and
a second parameter of the set of shaping parameters associated with a modulation mapping function; and
means for performing the second shaping operation on the second subset of bits according to a third equation of the one or more equations, wherein the third equation is associated with at least:
the first parameter of the set of shaping parameters; and
a third parameter of the set of shaping parameters associated with a uniform information bit distribution.

28. The wireless device of claim 21, further comprising:
means for performing an interleaving operation on the one or more symbols of the symbol sequence according to an interleaving configuration, wherein transmitting the symbol sequence is based at least in part on performing the interleaving operation.

29. The wireless device of claim 28, further comprising:
means for receiving control signaling comprising an indication of the interleaving configuration, wherein performing the interleaving operation on the one or more symbols of the symbol sequence is based at least in part on one or more parameters associated with the indication of the interleaving configuration.

30. A non-transitory computer-readable medium storing code for wireless communications, the code comprising instructions executable by one or more processors to:
obtain one or more subsets of bits;
perform both a first shaping operation on a first subset of bits of the one or more subsets of bits in accordance with a first probability distribution and a second shaping operation on a second subset of bits of the one or more subsets of bits in accordance with a second probability distribution different from the first probability distribution, wherein the first shaping operation and the second shaping operation utilize a same set of shaping parameters;
map the shaped first subset of bits and the shaped second subset of bits to one or more symbols of a symbol sequence; and
transmit, to a second wireless device, the symbol sequence based at least in part on mapping the shaped first subset of bits and the shaped second subset of bits to the one or more symbols.
